(19) United States
(12) Patent Application Publication
(10) Pub. No.: US 2008/0217220 A1
(43) Pub. Date: Sep. 11, 2008

(54) Combination Liquid Chlorinator and Bio Stimulated Fertilizer Feeder

(76) Inventor: Gary Reeves, Centerville, TX (US)

Correspondence Address: WILSON DANIEL SWAYZE, JR., 3804 CLEARWATER CT., PLANO, TX, 75025, US

(21) Appl. No.: 11/682,610

(22) Filed: Mar. 6, 2007

(51) Int. Cl. B01D 21/24

(52) U.S. Cl. 210/97

(57) ABSTRACT

A dispensing device for dispensing media and disinfectant includes a media housing, a disinfectant housing, a media input port formed on the media housing for accepting media fluid, a disinfectant input port formed on the disinfected housing for accepting disinfectant fluid, a disinfectant mixer for mixing the media fluid and the disinfectant fluid, and a float valve for the disinfectant mixer to dispense the mixed media fluid and disinfectant fluid. The media valve is controlled by a media regulator, and the media housing includes a media drain valve. The media housing includes a top section and a bottom section which is detachable connected to the top section, and the disinfectant housing includes a upper section and a lower section which is detachably connected to the upper section. The disinfectant housing includes a control valve for controlling the disinfectant fluid, and the disinfectant housing includes a disinfectant regulator to control the disinfectant control valve.

### FIELD OF THE INVENTION

The present invention relates to a feeder system and more particularly to a combination liquid chlorinator and Bio stimulated fertilizer feeder.

### BACKGROUND OF THE INVENTION

In the drier areas of the country, there is a need for a watering system that can be used to water lawns, plants and trees. Particularly, in large households, there is a large amount of water that is used for household needs such as laundry, bathing and toilet, and for the most part, this water is disposed of after being used. This water represents a potential source for the watering needs of the lawns, plants and trees. However, the wastewater may be unsanitary in the untreated state. There are various schemes for treating the wastewater in order to eliminate the unsanitary aspects. However, the schemes usually involve using a large quantity of chemicals which may result in the water being unsuitable for watering the lawns, plants and trees. Furthermore, the schemes are usually expensive as a result of having to purchase the large quantity of chemicals.

### SUMMARY

The present invention includes a Bio chlorinator/feeder which can be used with surface or subsurface irrigation such as sprinklers or drip line irrigation and not only aids in wastewater treatment but the Bio chlorinator/feeder enhances the vegetation growth and rebuilds the soil. The current aerobic systems are not designed to be a standalone irrigation system due to the low discharge. Furthermore, drip line systems become frequently clogged and require a licensed maintenance individual to backwash the drip system The typical aerobic system discharges approximately 200 to 500 gallons per day, and an average irrigation system can increase the water usage by an extra 500 to 1000 gallons of water. The Bio feeder of the present invention introduces media/Bio food (microorganisms for example heterotrophic bacteria, yeast, mold, nitrogen fixing bacteria, Actinomycetes, pseudomonades, and Anaerobic bacteria) by surface or subsurface methods. Since less water is used when fertilizer is applied to the roots of plants and trees, the Bio feeder of the present invention provides a viable source of water. The Bio feeder of the present invention can use the feeder of the media to introduce microorganisms to eat fungi and yeast that may stop up the drip line and emitter holes. The Bio feeder can be disconnected once the drip lines and emitter holes have been cleared. The bio feeder and chlorinator can be operated individually or operated together. Additionally, the discharge rate of the Bio feeder and the discharge rate of the chlorinator can be individually and independently set in order to accommodate the needs of the user. The Bio chlorinator/feeder operates at a low pressure from a pump effluent line and may only require a quart a minute of fluid to operate. The Bio chlorinator/feeder can be regulated in order to dispense an amount of chlorinator/feeder according to predetermined numbers found on a regulator. The present invention employs a check or drain valve that can be used to provide an indication of the rate of chlorine/feed material that is being dispensed. Since each aerobatic system does not require the same amount of chlorine/feed material, the rate of material being used is an important determination. A measuring cup can be used in conjunction with the drain valve to measure the material over a fixed rate of time. Consequently, the maintenance individual will be able to accurately determine if more or less chlorine/feed material is required. The Bio chlorinator/feeder does not require a source of electricity and does not use an injection pump. The Bio chlorinator/feeder is portable and does not interfere with the removal of the pump. The Bio chlorinator/feeder places disinfectant which may be chlorine adjacent to the screen of the pump to prevent fluid from being pumped without the disinfectant from being added. The Bio chlorinator/feeder of the present invention does not require that installed pumps be removed to accommodate the Bio chlorinator/feeder. A saddle can be attached to an existing pump pipe to connect to the Bio chlorinator/feeder. The disinfectant feed of the present invention is gravity fed and consequently, the disinfectant holder can be conveniently placed near the house with PVC pipe running to the Bio chlorinator/feeder. The Bio chlorinator/feeder of the present invention is capable of dosing at sufficiently high rates, enabling multiple pumps to be fed from a single Bio chlorinator/feeder. The Bio chlorinator/feeder mixes the disinfectant and media before they enter into the pump tank which eliminates separate pockets of media.

A dispensing device for dispensing media and disinfectant includes a media housing, a disinfectant housing, a media input port formed on the media housing for accepting media fluid, a disinfectant input port formed on the disinfected housing for accepting disinfectant fluid, a disinfectant mixer for mixing the media fluid and the disinfectant fluid, and a float valve for the disinfectant mixer to dispense the mixed media fluid and disinfectant fluid.

The media valve is controlled by a media regulator, and the media housing includes a media drain valve.
The media housing includes a top section and a bottom section which is detachable connected to the top section, and the disinfectant housing includes a upper section and a lower section which is detachably connected to the upper section.
The disinfectant housing includes a control valve for controlling the disinfectant fluid, and the disinfectant housing includes a disinfectant regulator to control the disinfectant control valve.
The disinfectant housing includes a disinfectant float valve for mixing the media fluid and the disinfectant float with a pump fluid, and the disinfectant housing includes a disinfectant float to control the disinfectant float valve.
The disinfectant housing includes a disinfectant drain valve.

### BRIEF DESCRIPTION OF THE DRAWING

The invention may be understood by reference to the following description taken in conjunction with the accompanying drawings, in which, like reference numerals identify like elements, and in which:

FIG. 1 illustrates a cross-sectional view of the media/disinfectant dispensing device of the present invention.

### DETAILED DESCRIPTION

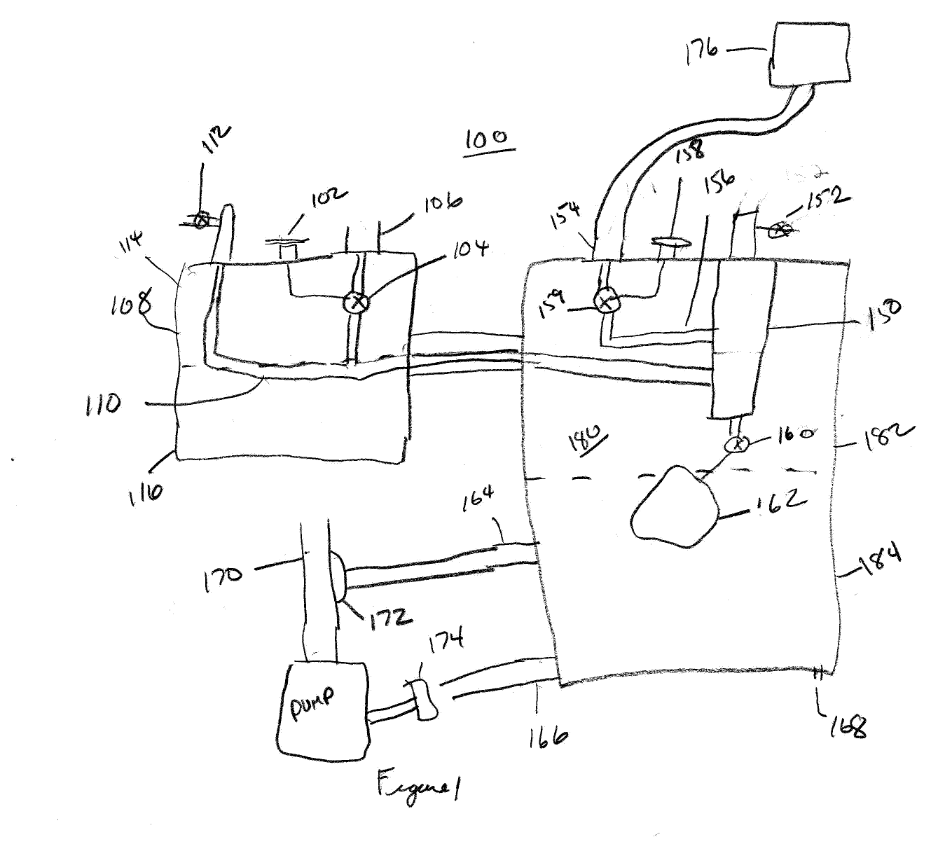

FIG. 1 illustrates a detachable media housing 108 which includes a top section 114 which can be detached from the bottom section 116 in order to correct problems. FIG. 1 additionally illustrates a media input port 106 to allow media fluid which will be referred to as media such as Bio stimulant fertilizer to be added as a fluid to the Bio Chlorinator/feeder 100 to the media passage 110. Mounted on the detachable media housing 108 is a media regulator 102 for regulating a media control valve 104 which is positioned in the media passage 110. The media regulator 102 may include a rotatable selector to select the amount of media that enters the disinfectant mixer 150.

FIG. 1 additionally illustrates a disinfectant housing 180 which includes an upper section 182 and the bottom section 184. The upper section 182 and the bottom section 184 are detachably connected to each other so that any problems within the disinfectant housing 180 can be corrected. FIG. 1 additionally illustrates a disinfectant input port 154 to input disinfectant fluid which will be referred to as disinfectant into the disinfectant mixer 150 through the disinfectant passage 156. The disinfectant passage 156 includes a disinfectant control valve 159 to control the amount of disinfectant passing through the disinfectant passage 156. The disinfectant control valve 159 is connected to the disinfectant regulator 158 which allows the user by turning the disinfectant regulator 158 to regulate and control the disinfectant control valve 159. FIG. 1 additionally illustrates a disinfectant drain valve 152 to drain the disinfectant mixer 150. The user can open the disinfectant drain valve 152 to determine the rate of disinfectant entering the disinfectant mixer 156. The disinfectant resides in the disinfectant source 176 which may be located adjacent to the house of the user. FIG. 1 additionally illustrates a pump line 170 which is connected to the output of the pump having a saddle 172 positioned on the pump line 170 to provide a convenient and fast device for tapping the pressurized fluid from the pump. The pump input 164 transports the fluid from the pump line 170 to the interior of the disinfectant housing 180. FIG. 1 additionally illustrates a pump output line 166 which outputs the fluid, the media, and the disinfectant to the screen 174 of the pump. If the pump line 170 is pressurized, fluid will enter the interior of the disinfectant housing 180 and raise the float 162. The float 162 will open the float valve 160 after the fluid has reached a predetermined level. The contents of the disinfectant mixer 150 including disinfectant and media will mix with the fluid and will flow to the pump screen 174.

In operation, the user adjusts the media regulator 102 to allow the media to enter the media input port 106 and through the media control valve 104. To test the rate of media flow, the user opens the media drain valve 112 and measures the rate of flow. The media flows to the disinfectant mixer 150 to mix with the disinfectant. In a similar fashion, the user adjusts the control valve 179 to allow the disinfectant to flow from the disinfectant source 176 to the disinfectant mixer 150. The disinfectant enters the disinfectant input port 154 and flows through the control valve 159 to flow to the disinfectant mixer 152 mix with the media.

When the pump is activated, the fluid pressure in the pump line 170 rises and the fluid flows to the interior of the disinfectant housing 180. When the fluid reaches a sufficient level which may be immediately when the pump pressurizes the fluid or any other suitable level, the float 162 or hollow bouncer opens the float valve 160 which releases the media and disinfectant to mix with the fluid within the interior of the disinfectant housing 180. When the pump shuts off, the fluid is removed from the interior of the disinfectant housing 108 through the weep hole 168, and the float 162 shuts off the float valve 160.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A dispensing device for dispensing media and disinfectant, comprising:
a media housing;
a disinfectant housing;
a media input port formed on the media housing for accepting media fluid a disinfectant input port formed on the disinfected housing for accepting disinfectant fluid;
a disinfectant mixer for mixing the media fluid and the disinfectant fluid;
a float valve for the disinfectant mixer to dispense the mixed media fluid and disinfectant fluid.

2) A dispensing device for dispensing media and disinfectant as in claim 1, wherein the media valve is controlled by a media regulator.

3) A dispensing device for dispensing media and disinfectant as in claim 1, wherein said media housing includes a media drain valve.

4) A dispensing device for dispensing media and disinfectant as in claim 1, wherein said media housing includes a top section and a bottom section which is detachable connected to the top section.

5) A dispensing device for dispensing media and disinfectant as in claim 1, wherein the disinfectant housing includes a upper section and a lower section which is detachably connected to the upper section.

6) A dispensing device for dispensing media and disinfectant as in claim 1, wherein the disinfectant housing includes a control valve for controlling the disinfectant fluid.

7) A dispensing device for dispensing media and disinfectant as in claim 6, wherein the disinfectant housing includes a disinfectant regulator to control the disinfectant control valve.

8) A dispensing device for dispensing media and disinfectant as in claim 1, wherein the disinfectant housing includes a disinfectant float valve for mixing the media fluid and the disinfectant float with a pump fluid.

9) A dispensing device for dispensing media and disinfectant as in claim 8, wherein the disinfectant housing includes a disinfectant float to control the disinfectant float valve.

10) A dispensing device for dispensing media and disinfectant as in claim 1, wherein the disinfectant housing includes a disinfectant drain valve.
